(19) United States
(12) Patent Application Publication
(10) Pub. No.: US 2023/0015952 A1
(43) Pub. Date: Jan. 19, 2023

(54) COMPOSITE SOLID ELECTROLYTE

(71) Applicant: Alexander Kosyakov, Albany, NY (US)

(72) Inventor: Alexander Kosyakov, Albany, NY (US)

(21) Appl. No.: 17/745,763

(22) Filed: May 16, 2022

Related U.S. Application Data
(60) Provisional application No. 63/161,496, filed on Mar. 16, 2021.

(51) Int. Cl. H01M 10/0562

(52) U.S. Cl. CPC H01M 10/0562; H01M 2300/0091; H01M 2300/0068; H01M 2300/0082

(57) ABSTRACT

A composite solid electrolyte comprises a first component comprising an aluminosilicate-based ceramic and a second component comprising a non-conductive polymer.

This patent application claims priority to United States Provisional Patent Application 63/161,496 filed on March 16, 2021, the entirety of which is incorporated herein by reference.

### GOVERNMENT ASSISTANCE

In accordance with 35 U.S.C. § 202(c)(6), Applicant hereby states that the invention disclosed in this specification was made with United States of America Federal Government support (the Department of Defense, contract number FA864921P0559) and the United States of America FederalGovernment has certain rights in the invention.

### TECHNICAL FIELD

The present teachings relate generally to solid electrolytes, and more specifically to a composite solid electrolyte comprising a ceramic material and a polymer material.

### BACKGROUND

The challenges of fossil fuel-driven climate change and increasing global energy demands have increased the need for electric vehicles and wind- and solar-powered electrical grids. These applications require high performance from energy storage systems, such as batteries.

Lithium-ion batteries (LIBs) have been atechnological mainstay for the last two decades, but many issues are associated with their use in electric vehicles.. Prevailing LIB designs implement liquid electrolyte (“LE”)-soaked separator membranes or cloth in between the electrodes. The LEs are typically 1M solutions of lithium hexafluorophosphate (LiPF6) in mixtures of ethylene carbonate (EC), ethyl methyl carbonate (EMC), diethyl carbonate (DEC), dimethyl carbonate (DMC), and other organic solvents. Meanwhile, the separator membranes can be as thin as 15 μm and are typically made from polypropylene (PP), polyethylene (PE), or a composite of both. Though LEs have seen few transformational innovations in the past two decades as research has concentrated on resolving capacity bottlenecks at the cathodes and anodes of batteries, electrolyte technology has recently become ripe for disruption due to the immense safety concerns now facing existing LIBs.

LEs are the principal cause of thermal runaway in LIBs. Their inherent volatility makes them susceptible to combustion at temperatures as low as 60° C. Their flammability can also be triggered by short circuits stemming from external puncture damage or internal dendritic growth. Consequently, manufacturers have been forced to apply fixes at the battery pack level that essentially “babysit” LIB cells. These fixes include active liquid cooling systems and battery management systems (BMS) electronics that carefully monitor the stability of cells. However, these systems reduce efficiency, inflate costs, and are not fail-proof—as demonstrated by recent electric vehicle recalls due to battery safety issues.

Aside from impeding current LIB energy performance with their safety faults, LEs are also presenting obstacles to the utilization of new high-performance battery components. LEs possess electrochemical stability windows with a typical upper bound of ˜4.5V. This complicates the utilization of high-capacity chemistries using 5V electrodes such as nickel-rich layered oxide or spinel-type cathode materials cathodes or Li-metal anodes. Li-metal anodes are especially primed for market introduction due to their theoretical capacity of over 3000 mAh/g (conventional graphite anodes have a theoretical capacity of 370 mAh/g); however, LEs are particularly unsuitable for use with Li-metal due to their lack of durability in the face of the significant volumetric expansion and dendritic growth that Li-metal experiences after repeated charge/discharge. LEs are also extremely electrochemically unstable against Li-metal and decompose rapidly which degrades battery capacity over the course of just a few charge-discharge cycles.

As a result of LEs' limitations, the battery industry has seen a recent explosion of advancement in solid-state electrolytes (SSEs) for LIBs. SSEs are typically made from ceramic or polymer materials..

Ceramics function on the principle of ions “hopping” through defect sites in the crystal lattice. Common ceramic SSEs include lithium “garnets”, NASICON- and LISICON-type structures, and sulfides. Exceptional room temperature ion transport can be achieved by ceramics—especially sulfides. Room temperature ionic conductivities in excess of 1×10⁻³ S/cm have been reported, which is comparable to LEs.

However, ceramics come with an array of drawbacks. First, they are notoriously difficult to synthesize, handle, and implement. Ceramics often require multiple high-temperature firings to refine their grain boundaries and can use exotic impurities or secondary phases. Sulfides are particularly unstable in open air when produced, and are not stable against Li-metal. Ceramics are also brittle and weak in stress. They cannot be used in cylindrical cells and can crack from the pressures of expanding electrode components or dendrites; some ceramics, such as garnet-type materials, can even experience dendrite growth directly through their structural channels. Thus, ceramic SSEs are often made to be thick (70₁.tm or more), which significantly compromises cell design efficiency. Finally, ceramic SSEs suffer from high interfacial resistance. A common strategy to circumvent interfacial resistance is to add LE to the interface between their ceramic and electrodes, but this nullifies the fire safety improvements of the SSE. Other companies sinter their ceramic SSEs to their electrodes. However, this adds another high-temperature firing step as the materials have to be brought to their Tammann temperature (one-half of their melting temperature).

Polymers, meanwhile, facilitate ion transport by the segmental motion of their chains above their glass transition temperature (T_{g}). However, polymer SSEs struggle to achieve fast ion transport at room temperature.

Thus, there is a need to develop novel solid electrolytes that address and overcome above-mentioned problems in the art.

### SUMMARY

The needs set forth herein as well as further and other needs and advantages are addressed by the present embodiments, which illustrate solutions and advantages described below.

It is an object of the present teachings to provide a composite solid electrolyte that leads to the advent of safe, cost-effective solid- electrolyte-based energy storage systems for widespread electric mobility (including automotive, aerospace, and marine vehicles), electronic devices, renewable energy systems, and the like.

It is another object of the present teachings to provide a composite solid electrolyte that minimizes electric vehicle battery pack material costs and maximizes chemical and thermal stability at the cell level by eliminating many of the cooling and battery management systems typically used at the pack level to achieve improved durability and scalability.

It is another object of the present teachings to provide an optimized battery with solid electrolyte having high ionic conductance, improved softness, flexural strength, and overall survivability to facilitate high energy density, long cycle life, improved operating temperature, and increased voltage range in battery cells.

It is a further obj ect of the present teachings to provide a composite solid electrolyte that leads to the advent of safe, cost-effective solid-state lithium-ion batteries-based energy storage systems for EV adoption. It is a further object of the present teachings to provide an optimized solid-state lithium-ion battery with high energy density and high cycle life.

It is a further object of the present teachings to provide an optimized solid-state lithium-ion battery with solid electrolyte having high ionic conductance. It is a further obj ect of the present teachings to provide an optimized solid-state lithium-ion battery with long cycle life. It is a further object of the present teachings to provide an optimized solid-state lithium-ion battery with solid electrolyte having improved softness, flexural strength, and overall survivability.

It is a further object of the present teachings to provide an optimized solid-state lithium-ion battery with an improved operating temperature range.

These and other objects of the present teachings are achievedby providing a composite solid electrolyte, comprising a first component comprising an aluminosilicate-based ceramic; and a second component comprising a polymer.

The present teachings also provide a composite solid electrolyte, comprising a first component comprising a metakaolin aluminosilicate ceramic; and a second component comprising polyethylene oxide.

The present teachings also provide a composite solid electrolyte, comprising a first component comprising a metakaolin aluminosilicate ceramic; and a second component comprising polyvinylidenefluoride.

The present teachings also provide a composite solid electrolyte, comprising a first component comprising an aluminosilicate ceramic; and a second component comprising polyvinylidenefluoride.

The present teachings also provide an improved method of making solid electrolyte. The present teachings also provide an improved method of making thin solid electrolyte products, including Lithium-Ion Solid Ionic Composite (LISIC)-coated separator membranes.

The present teachings also provide an improved electrode that allows for greater areal density. The present teachings also provide carbon structures, including nanostructures like nanofibers and nanotubes, decorated with zinc oxide for improved plating of lithium..

The present teachings also provide the use of several elements as plasticizers in the production of solid electrolytes, including triethyl phosphate (TEP).

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

FIG. 1A illustrates a cell used for an electrochemical impedance spectroscopy (EIS) experiment.

FIG. 1B illustrates an equivalent resistance circuit used for calculating the ionic conductance in an electrochemical impedance spectroscopy (EIS) experiment.

FIG. 2 is a flow diagram illustrating the production of a solid electrolyte in an embodiment.

FIG. 3 is a flow diagram illustrating the production of a solid electrolyte with doping in an embodiment.

FIG. 4 is a flow diagram illustrating cathode infiltration in an embodiment.

FIG. 5 is a flow diagram illustrating ZnO carbon in an embodiment.

FIG. 6 illustrates thermal stability in an embodiment.

FIG. 7 illustrates a charge/discharge plot of an embodiment.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

In compliance with the statute, the present teachings have been described in language more or less specific as to structural and methodical features. It is to be understood, however, that the present teachings are notlimited to the specific features shown and described, since the systems andmethods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so asnot to obscure the description with unnecessary detail.

Generally, all terms are to be interpreted according to their ordinary meaning in the technical field, unless explicitly defined otherwise herein. All references to a/an/the element, composition, apparatus, component, means, step, etc., are to be interpreted openly as referring to at least one instance of the element, composition, apparatus, component, means, step, etc., unless explicitly stated otherwise. The steps of any method disclosed herein do not have to be performed in the exact order disclosed, unless explicitly stated. The use of “first,” “second,” etc. for different features/components of the present disclosure are only intended to distinguishthe features/components from other similar features/components and not to impart any order or hierarchy to the features/components.

In the prior art, it has been shown that ceramics have good performance but poor mechanical and interfacial attributes, while polymers possess favorable mechanical properties but lack performance. The present system combines ceramics and polymers into composite solid electrolytes (CSEs) that hybridize both classes of materials.

The term “composite solid electrolyte” in one embodiment refers to the addition of ceramic particles to a continuous polymer matrix (a “ceramic-in-polymer” system). In CSEs the ceramic can be active—where the ceramic possesses intrinsic ion transport capability—or inactive—where the ceramic improves the ion transport capabilities of the surrounding polymer.

The present teachings provide a composite solid electrolyte material that can be used on existing battery assembly lines and can directly replace current separator membranes, or used to coat current separator membranes. The solid electrolyte eliminates the need for unstable liquid electrolytes. Unlike prior art solid electrolytes, the present product is easier to produce and has superior performance properties than prior art solid electrolytes. The solid electrolyte is a combination of a ceramic material and a polymer material. The result is a dense composite that has little or no porosity, and does not have a high concentration of lithium salt or plasticizer material. In one embodiment, the material is a Lithium-Ion Solid Ionic Composite (LISIC), a polymer-ceramic composite solid electrolyte for rechargeable LIBs.

The solid electrolyte may comprise an aluminosilicate ceramic material and non-conducting polymer material. The non-conducting polymer may be doped with or without ions. In one embodiment, the aluminosilicate ceramic particles may be incorporated into the non-conducting polymer matrix. In another embodiment,the aluminosilicate ceramic material may be served as a dopant to be incorporated into the non-conducting polymer.

According to one embodiment, the present teachings provide a composite solid electrolyte material including an aluminosilicate ceramic material (lepidolite in one embodiment) and polyvinylidene fluoride (PVdF) polymer material. PVDF possesses improved thermal stability as compared to PEO while still possessing a low enough Tg for fast ion transport at typical battery operating conditions. In addition, PVDF is already used as a binder for battery electrodes: electrode active material powder is usually mixed into a slurry with conductive carbon, PVDF powder, and N-methyl-2-pyrrolidone (NMP) solvent before being cast onto metal current collectors. Thus, supply chains and economies of scale are already well-established for PVDF. However: PVDF is highly polarizable. PVDF possesses a complex and poorly understood polymorphism entailing a nonpolar a phase and polar β, γ, and δ phases, and few attempts have been made to analyze the factors contributing to the formation of these distinct phases during solution casting of PVDF.

The PDVF may be doped with or without lithium salt at the interface between the LISIC and the Li-metal, such as:

Lithium perchlorate

Lithium bis(trifluoromethanesulfonyl)imide (LiTF SI)

Lithium bis(fluoromethanesulfonyl)imide (LiFSI)

Lithium hexafluorophosphate

Lithium chloride

Lithium fluoride

Lithium iodide

Lithium nitrate

In one embodiment, the aluminosilicate ceramic particles may be incorporated into a polyvinylidene fluoride polymer matrix. Performance in embodiments is illustrated in the Appendix.

In one embodiment, the aluminosilicate ceramic material is a mica mineral of high lithium content, with formula K(Li,Al,Rb)2(Al,Si)4O10(F,OH)2. In other embodiments, the product uses Metakaolin, metahalloysite, and the like for the ceramic material.

The polyvinylidene fluoride (PVdF) is a polymer with repeat structural unit CH2CF2. PVdF is formed by polymerization of vinylidene difluoride. PVdF has excellent fire-retardant properties and is already used in fire insulation applications, such as a fire insulation coating material in building construction.

Prior art solid electrolytes have used polyethylene oxide (PEO) as a polymer. Disadvantages of PEO include a much lower glass transition (T_{g}) temperature than PVdF, as well as a much lower melting temperature than PVdF. The low melting temperature of PEO impacts thermal stability in operating environments.

The composite solid electrolyte material according to the present teachings incorporates ceramic material and polymer material. The composite solid electrolyte material according to the present teachings can be tuned for optimized properties by varying the composition of the polymer and ceramic as well as doping with aluminosilicate that reduces the crystallinityof the PVdF and increase lithium ion concentration. The PVdF also lends elastic properties that improve the electrolyte's resistance to cracking from internal strains inside battery cells.

The composite solid electrolyte material according to the present teachings has properties that combine the high ionic conductivity of metakaolin and the low interfacial resistance and elasticity of PVdF. The composite solid electrolyte according to the present teachings retains high thermal resilience and is highly compatible with different electrode systems and capable of being used in cylindrical cells. The composite solid electrolyte according to the present teachings not only has high thermal stability but also high compatibility with existing lithium-ion batteries. The composite solid electrolyte according to the present teachings can be implemented in existing production lines of LFP battery manufacturing in the place of liquid electrolytes to mitigate any fire and short circuit risks that their chemistries currently possess.

The composite solid electrolyte according to the present teachings is flexible and durable. The composite solid electrolyte according to the present teachings presents a barrier to short-circuit causing dendrites and is thermally stable to >250° C. to present a far safer alternative to liquid electrolytes.

To address the problem that existing energy storage systems using leading lithium-ion batteries and other liquid electrolyte chemistries require external management and thermal systems that inflate costs and reduce efficiency, the battery that uses the composite solid electrolyte according to the present teachings is designed to provide intrinsic safety to eliminate external systems and facilitate battery pack-level cost efficiencies.

The synthetic process of a composite solid electrolyte according to the present teachings will be illustrated using the examples. Example 1 illustrates an exemplary process for synthesis of a composite solid electrolyte that is an aluminosilicatecomposite without doping according to the present teachings. Example 2 illustrates an exemplary process for synthesis of a composite solid electrolyte that is an aluminosilicate composite with lithium ion doping according to the present teachings.

The production of the solid electrolyte is accomplished by mixing the ceramic and the polymer in the presence of a plasticizer or solvent. An aluminosilicate ceramic can be used to encage plasticizer in LISIC while also aggrandizing the ion conductivity capabilities of the continuous PVDF phase. An embodiment is synthesized from a type of clay mineral that is highly abundant and already extracted in large quantities for uses in the paper and cosmetics industries. This ceramic is capable of intrinsic ionic conductivity on the order of 1×10-7 S/cm, but most compelling is its ability to uptake and intercalate into its interlayer plasticizer that would be independent of the bulk PVDF. Also, the ceramic also provides large Lewis acid surfaces for solvating and improving the motion of Li salt in the polymer matrix.

### EXAMPLE 1

### Synthesis of Aluminosilicate Composite (without Doping)

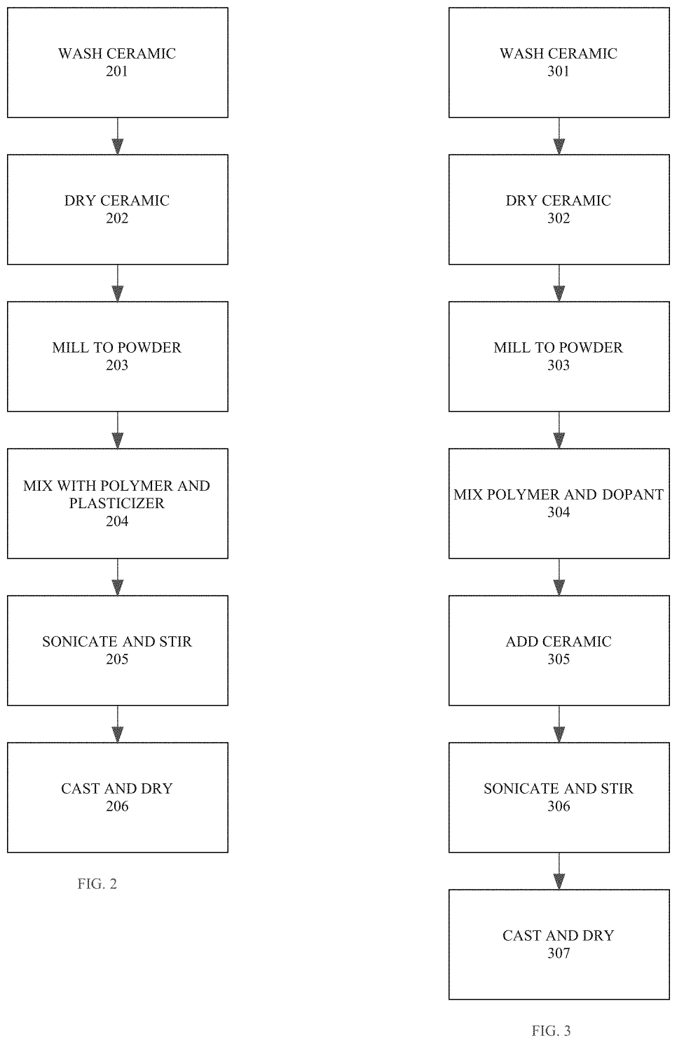

FIG. 2 is a flow diagram illustrating the production of a solid electrolyte using the process of Example 1. The aluminosilicate is widely available commercially as a crushed powder. The powder is first washed with deionized water and ethyl alcohol multiple times at step 201 before being dried in a vacuum oven at step 202. The dried aluminosilicate is then ball milled to reduce particle size, forming the aluminosilicate powder at step 203.

In one embodiment, the powdered lepidolite is dispersed with PVdF in a plasticizer at step 204. In one embodiment the plasticizer is triethyl phosphate (TEP). It has been found that the TEP, being nonvolatile and nonflammable, improves the thermal stability of the resulting product.

In one embodiment, dimethylformamide (D1VIF) solvent is used as the solvent/plasticizer. The plasticizer may also be dimethyl acetamide (DMAC), N-methyl-2pyrrolidone (NMP), trimethyl phosphate (TMP), and the like.

The ceramic, polymer, and plasticizer form slurries with aluminosilicate/PVdF. The weight percentage of the poweredaluminosilicate and the PVdF may be varied. In one embodiment, the powdered aluminosilicate is 5 wt. % and the PVdF is 95 wt. %. In another embodiment, the powdered aluminosilicate is 10 wt. % and the PVdF is 90 wt. %. In another embodiment, the powdered aluminosilicate is 15 wt. % and the PVdF is 85 wt. %. Inanother embodiment, the powdered aluminosilicate is 20 wt. % and the PVdF is 80 wt. %. In another embodiment, the powdered aluminosilicate is 25 wt. % and the PVdF is 75 wt. %. In another embodiment, the powdered aluminosilicate is 30 wt. %and the PVdF is 70 wt. %. In another embodiment, the powdered aluminosilicate is 35 wt. % and the PVdF is 65 wt. %. In another embodiment, the powdered aluminosilicate is 40 wt. % and the PVdF is 60 wt. %. In another embodiment, the powdered aluminosilicate is 45 wt. % and the PVdF is 55 wt. %. In yet another embodiment, the powdered aluminosilicate is 50 wt. % and the PVdF is 50 wt. %.

At step 205, the plasticizer slurries with aluminosilicate/PVdF are mixed until homogeneous slurries are acquired. The slurries are cast into molds. The casts will be allowed to dry in a vacuum oven to obtain the aluminosilicate composite that can be used as solid electrolyte at step 206.

### EXAMPLE 2

### Synthesis of Aluminosilicate Composite with LiClO4 Doping

FIG. 3 is a flow diagram of the production of a solid electrolyte using the process of Example 2. The aluminosilicate is ball milled at step 303 to reduce particle size, forming the aluminosilicate powder.

PVdF and a dopant LiClO4 are first added to a plasticizer (e.g. TEP) solvent at step 304. The dopant lithium salt may also be lithium bis(triflouromethanesulfonyl)imide (LiTF SI), lithium bis(flouromethanesulfonyl)imide (LiF SI), lithium hexafluorophosphate, lithium chloride, lithium iodide, lithium nitrate, and the like.

The powdered aluminosilicate is then added at step 305, forming the slurries with aluminosilicate/PVdF/LiClO4. The weight percentage of the powered aluminosilicate and the PVdF may be varied. In one embodiment, the powdered aluminosilicate is 5 wt. % and the PVdF is 95 wt. %. In another embodiment, the powdered aluminosilicate is 10 wt. % and the PVdF is 90 wt. %. In another embodiment, the powdered aluminosilicate is 15 wt. % and the PVdF is 85 wt. %. In another embodiment, the powdered aluminosilicate is 20 wt. % and the PVdF is 80 wt. %. In another embodiment, the powdered aluminosilicate is 25 wt. % and the PVdF is 75 wt. %. In another embodiment, the powdered aluminosilicate is 30 wt. % and the PVdF is 70 wt. %. In another embodiment, the powdered aluminosilicate is 35 wt. % and the PVdF is 65 wt. %. In another embodiment, the powdered aluminosilicate is 40 wt. % and the PVdF is 60 wt. %. In another embodiment, the powdered aluminosilicate is 45 wt. % and the PVdF is 55 wt. %. In yet another embodiment, the powdered aluminosilicate is 50 wt. % and the PVdF is 50 wt. %.

At step 306 the slurries with aluminosilicate/PVdF/LiClO4 mixed until homogeneous slurries are acquired. The slurries are cast intomolds. The casts will be allowed to dry to obtain the aluminosilicate composite that can be used as solid electrolyte at step 307.

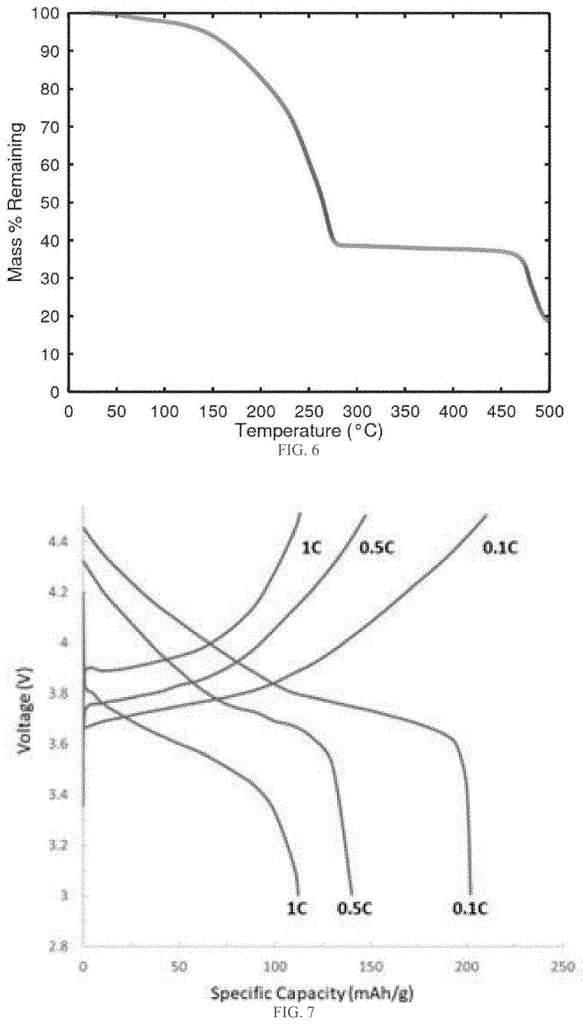

After the synthesis of aluminosilicate composite without doping as shown in Example 1 and aluminosilicate composite with lithium ion doping as shown in Example 2, the resulted aluminosilicate composite with or withoutdoping may be characterized for thermal stability as shown in FIG. 6, for example, using thermogravimetric analysis (TGA), and for iconic conductance, for example, using Electrochemical Impedance Spectroscopy (EIS). The resulted aluminosilicate-PVdF composite with or without doping may be further analyzed using X-raydiffraction (XRD) by using Cu Ka radiation (λ=1.5405 angstrom) in 20 range of 10°-70° to determine the crystallinity or lack thereof. The resulted aluminosilicate-PVdF composite with or without doping may be further analyzed using scanning electron microscope (SEM).

The thermogravimetric analysis (TGA) may be performed with isothermal TGA experiments at 200° C., as well as dynamic TGA experiments between 30° C. and 200° C. The TGA experiments will yield mass-loss percentage vs degree/time plots to quantify the thermal degradation of the aluminosilicate composite with or without doping.

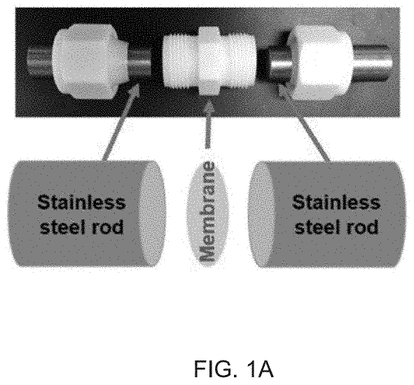

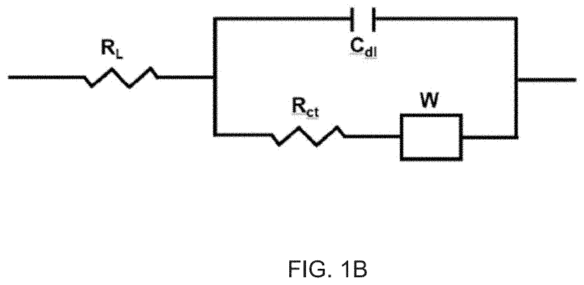

The Electrochemical Impedance Spectroscopy (EIS) may be performed with a Swagelok cell as shown in FIG. 1A. This cell is reusable and the tested material is placed as sandwiched between two stainless steel electrodes as shown in FIG. 1B. The EIS experiments will yield a Nyquist plot with measured frequency ranging from 10⁶ to 10⁻¹ Hz. The ionic conductance of the tested material is calculated using the equation: σ=_L/AR wherein a is the ionic conductance, L is the thickness of the tested material and A is the area of the tested material, and R is the resistance of the tested material obtained by simulating the EIS data from the Nyquist plots with an equivalent resistance circuit as shown in FIG. 1B. Referring to FIG. 1B, R_{L}, represents the resistance of the tested material, R_{ct} represents the charge transfer resistance, C_{d1} represents the electrochemical double-layer capacitance, and W represents the Warburg diffusion element that models thediffusion process.

The calculated σ values determines the ionic conductance of the tested material. The calculated σ values may be used to determine the temperature dependence of the aluminosilicate-PEO composite performance.

Conductance is temperature-dependent through an Arrhenius relationship, soroom temperature conductance of 1×10⁻⁴ S/cm will be necessary to ensure viability in the −30° C.-100° C. range, which is not only necessary to validate fire safety, but also cold weather performance that is required by some applications. The activation energy (Eₐ) of the aluminosilicate composite is estimated using the Arrhenius equation: σT=A exp (Eₐ/kT), where T is the kT temperature and A is the pre-exponential factor. Arrhenius plots derived from this equation may be used to predict ionic conductance at varyingtemperatures.

The composite solid electrolyte according to one embodiment of the present teachings may be used to form a lithium-ion battery. The lithium-ion battery can have 200 Wh/L volumetric energy density. The lithium-ion battery can have an operating temperature range of −30° C. to 100° C. Applicable cathodes for the aluminosilicate/PVdF system may include LiFePO4 (LFP), LiNiₓMn_{y}Co_{z}O₂ (NMC) cathodes, and other cathode materials. Applicable anodes for the aluminosilicate/PVdF system may include lithium-metal anode, graphite anode, silicon anode, silicon-carbon composite anode, and other anodes.

In one embodiment, the product may also include a carbonate additive to improve interfacial compatibility with electrodes, including flouroethylene carbonate (FEC), vinylidene carbonate (VC), and the like.

The present teachings provide an improvement in electrode processing. Solid state batteries rely on stack pressure to mitigate lithium voids and dendrites on the anode side. However, stack pressure reduces energy density at the full size cell level because it requires inefficient cell designs. The solid electrolyte does not require pressure to have low interfacial resistance or to stop dendrites and/or voids on the anode side.

FIG. 4 is a flow diagram illustrating cathode infiltration in an embodiment. At step 401 a cell is constructed with NNIC532, lithium metal, the solid electrolyte of the teachings. At step 402 the cell is cold pressed at one atmosphere. At step 403 the cell is heat treated. In one embodiment, the cell is heated for six hours at 80 degrees C. and then rested at step 404 for 24 hours.

The solid electrolyte becomes viscous during the heat treatment and flows into the pores of the cathode, obviating the need for stack pressure. This achieves good interfacial coverage of cathode active material particles. Using this technique allows for charging of NNIC532 to 4.5V (instead of prior art 4.2V) extracting more capacity from the cell. For example, see the charge/discharge plot of FIG. 7.

The slurry formed during production of the solid electrolyte can be used as a binder system for battery electrodes. The slurry is combined with conductive carbon and electrode active material powder to facilitate high ionic and electronic performance for thick (e.g. greater than 100 micrometers) cathodes. It can also be used with anodes as well.

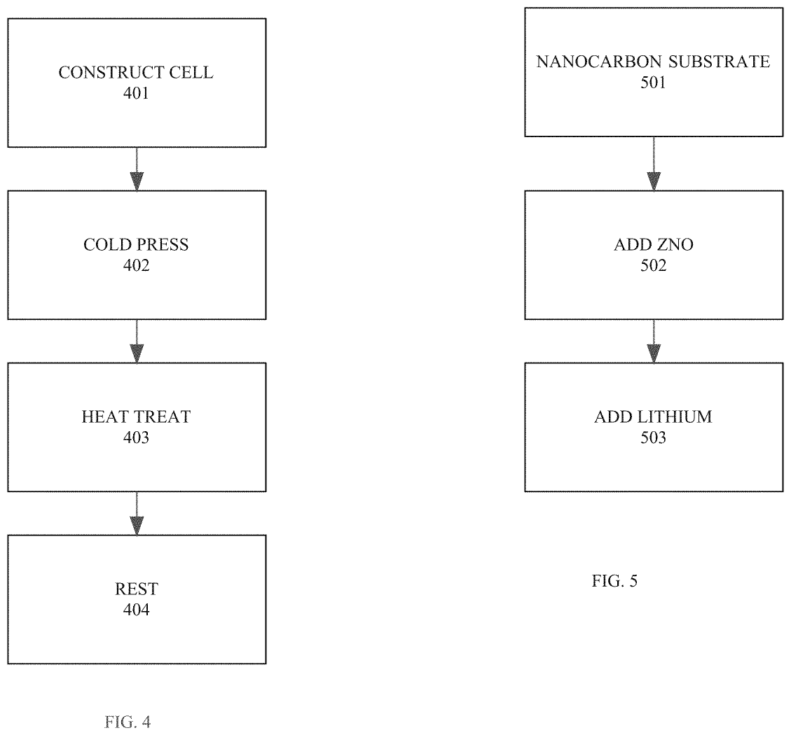

Improved cells can be produced by using a zinc oxide (ZnO)-decorated carbon. FIG. 5 is a flow diagram illustrating the process in an embodiment. At step 501 carbon nanoparticles are used to create a substrate. At step 502 the substrate is coated with ZnO. ZnO is lithiophilic. When a nanocoating of lithium metal is added at step 503, the porous carbon provides optimized free volume for expansion of lithium metal during lithium plating (as well as electrode infiltration of the slurry).

The resulting electrodes show rapid charging and discharging cycling capabilities. In one embodiment, NNIC811 is used to create a cathode with a high (e.g, 5 mAh/cm² areal density).

While the present teachings have been described above in terms of specific embodiments, it is to be understood that they are not limitedto these disclosed embodiments. Many modifications and other embodimentswill come to mind to those skilled in the art to which this pertains, and which are intended to be and are covered by this disclosure.

We claim:

1. A composite solid electrolyte, comprising:
a first component comprising a ceramic; and a second component comprising a polymer.

2. The composite solid electrolyte of claim 1, wherein the ceramic is an aluminosilicate ceramic.

3. The composite solid electrolyte of claim 1, wherein the polymer is a polyvinylidene fluoride.

4. The composite solid electrolyte of claim , wherein the aluminosilicate is a lepidolite aluminosilicate.

5. The composite solid electrolyte of claim 1, wherein the polymer polymer is doped with lithium ion.

6. The composite solid electrolyte of claim 4, wherein the lepidolite aluminosilicate ceramic has a weight percentage in a range of 5% to50%.

7. The composite solid electrolyte of claim 1, wherein the composite solid electrolyte is used in a lithium-ion battery and the lithium-ion battery comprises a cathode selected from at least one of lithium-iron-phosphate cathode and nickel-manganese-cobalt cathode, and an anode selected from at least one of lithium-metal anode, graphite anode, silicon anode, and silicon-carbon composite anode.

8. A method for fabricating a composite solid electrolyte, the method comprising:
providing a first component comprising a ceramic;
providing a second component comprising a polymer; and mixing the first component with the second component in the presence of a plasticizer to form a slurry;
sonicating the slurry;
magnetically stirring the slurry;
casting the slurry and drying the slurry to form the composite solid electrolyte.

9. The method of claim 8, wherein furtherincluding an ion doping material in the slurry.

10. The method of claim 9, wherein the ion doping material is a lithium ion doping material.

11. The method of claim 9, wherein the ion doping material is lithium perchlorate.

12. The method of claim 8 wherein the plasticizer comprises triethyl phosphate.

13. The method of claim 15, further comprising adding the mixed first and second components into dimethylformamide; sonicating, stirring, casting, and drying the components-added dimethylformamide to formthe composite solid electrolyte.

14. The method of claim 17, further comprising adding the mixed first and second components into dimethylformamide; sonicating, stirring, casting, and drying the components-added dimethylformamide to form the composite solid electrolyte.
